(19) United States
(12) Patent Application Publication
(10) Pub. No.: US 2025/0330545 A1
(43) Pub. Date: Oct. 23, 2025

(54) CONTROL DEVICE AND IMAGE FORMING APPARATUS

(71) Applicant: Toshiba Tec Kabushiki Kaisha, Tokyo (JP)

(72) Inventor: Takashi TOMIYAMA, Sunto Shizuoka (JP)

(21) Appl. No.: 19/050,527

(22) Filed: Feb. 11, 2025

(30) Foreign Application Priority Data
Apr. 17, 2024 (JP) 2024-067037

(51) Int. Cl. H04N 1/32; G03G 15/08

(52) U.S. Cl. CPC H04N 1/32138; G03G 15/0863; H04N 2201/3226

(57) ABSTRACT

According to an embodiment, a control device repeatedly transmits tag information associated with a mask pattern, a selection command to select a wireless tag associated with the mask pattern among a plurality of wireless tags, and a write command to cause a wireless tag communication device to write the tag information associated with the mask pattern to the wireless tag communication device for each mask pattern stored in a storage device.

### CROSS-REFERENCE TO RELATED APPLICATIONS

This application is based upon and claims the benefit of priority from the prior Japanese Patent Application No. 2024-67037, filed on Apr. 17, 2024, the entire contents of which are incorporated herein by reference.

### FIELD

An embodiment described herein generally relates to a control device and an image forming apparatus.

### BACKGROUND

An image forming apparatus capable of forming images on print media with a plurality of radio frequency identification (RFID) tags attached thereto has been conventionally known.

Here, the conventional image forming apparatus detects individual RFID tags after a print medium is conveyed to a position at which tag information is to be written to the plurality of RFID tags. The image forming apparatus then writes the tag information to the RFID tags for each of the detected RFID tags. However, the time required to detect the plurality of RFID tags increases as the number of RFID tags attached to the print medium increases. This leads to a decrease in user convenience, which is not desirable.

### BRIEF DESCRIPTION OF THE DRAWINGS

FIG. 1 is a diagram showing an example of a configuration of an image forming apparatus according to an embodiment.

FIG. 2 is a diagram showing an example of a configuration of a tagged print medium according to the embodiment.

FIG. 3 is a diagram showing an example of a functional configuration of a control device according to the embodiment.

FIG. 4 is a diagram showing an example of a processing flow in which the image forming apparatus according to the embodiment performs write and print processing.

FIG. 5 is a diagram showing an example of a processing flow in which a wireless tag communication device 13 according to the embodiment writes tag information to a wireless tag.

### DETAILED DESCRIPTION

According to one embodiment, a control device controls an image forming apparatus capable of forming an image on a print medium provided with a plurality of wireless tags. The control device includes a storage device, an interface, and a controller. The storage device is configured to store a mask pattern and tag information associated with the mask pattern for each of the plurality of wireless tags. The interface is connected to a wireless tag communication device capable of writing the tag information to the plurality of wireless tags. The controller is configured to repeatedly transmit the tag information associated with the mask pattern, a selection command to select a wireless tag associated with the mask pattern among the plurality of wireless tags, and a write command to cause the wireless tag communication device to write the tag information associated with the mask pattern to the wireless tag communication device via the interface for each mask pattern stored in the storage device.

An image forming apparatus according to an embodiment will be described with reference to the drawings. In each figure, the same configuration is denoted by the same reference symbol. An image forming apparatus 1 will be described as an example of the image forming apparatus according to the embodiment.

### Configuration of Image Forming Apparatus

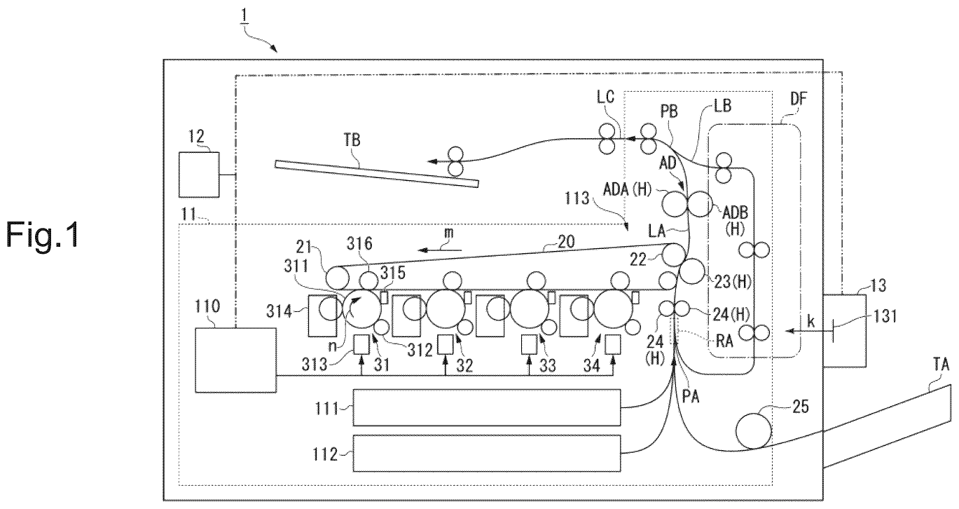

A configuration of the image forming apparatus 1 will be described with reference to FIG. 1. FIG. 1 is a diagram showing an example of a configuration of the image forming apparatus 1 according to the embodiment.

The image forming apparatus 1 is an apparatus that forms an image on a print medium. For convenience of description, forming an image on a print medium will be referred to as printing an image on a print medium. For example, the image forming apparatus 1 is a multifunction device, a copier, a printer, etc. The image forming apparatus 1 is disposed, for example, in a workplace. The print medium is a medium on which the image forming apparatus 1 performs processing such as printing an image. The print medium may be any sheet-shaped medium as long as images can be printed on at least one of its both surfaces. For example, the print medium is a sticker base, printing paper, a plastic film, etc.

The image forming apparatus 1 identifies the type of print media on which processing desired by a user is performed in response to an operation received from the user. The print media are classified into types on the basis of the size of a print medium, the thickness of a print medium, the material of a print medium, the presence or absence of wireless tags, and the like. A print medium with a wireless tag refers to a print medium with a plurality of wireless tags attached thereto. A print medium without wireless tags refers to a print medium without wireless tags. For convenience of description, a print medium with wireless tags will be referred to as a tagged print medium, and a print medium without wireless tags will be referred to as a tag-free print medium.

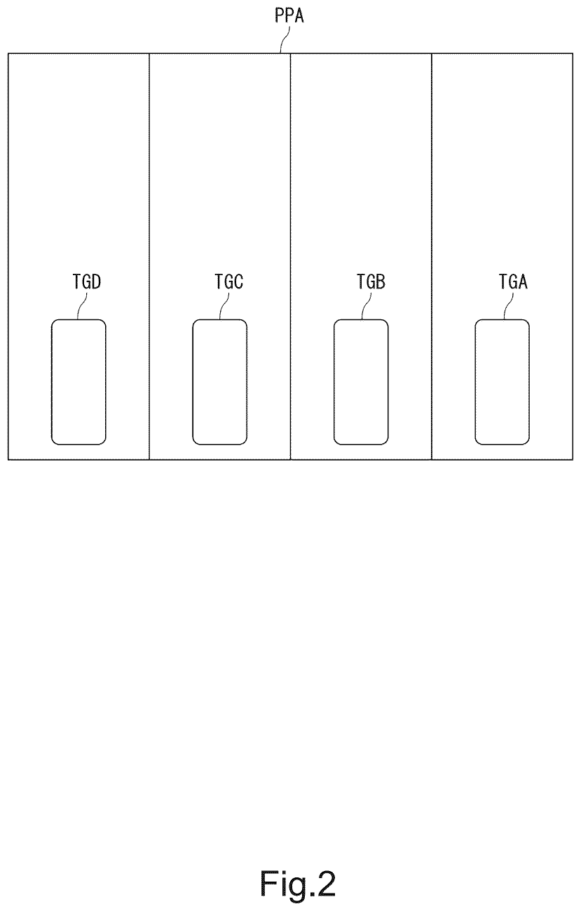

The wireless tag is, for example, but not limited to, a radio frequency identification (RFID) tag. FIG. 2 is a diagram showing an example of a configuration of a tagged print medium. A print medium PPA shown in FIG. 2 is an example of a tagged print medium. The print medium PPA is a sticker base with four stickers. Wireless tags TGA to TGD shown in FIG. 2 are examples of respective wireless tags attached to the four stickers of the print medium PPA that is a sticker base. Each of the wireless tags TGA to TGD includes an integrated circuit (IC) chip and an antenna. The IC chip is an IC chip to/from which tag information is written/read. The antenna is connected to the IC chip and, for example, receives tag information to be written to the IC chip and transmits tag information read from the IC chip. In FIG. 2, each of the wireless tags TGA to TGD is illustrated as a rectangular object with rounded corners in order to simplify the figure.

The image forming apparatus 1 prints an image on a print medium of a type specified in advance in response to an operation received from the user. For example, if a print medium of a type specified in advance in response to an operation received from the user is a certain tagged print medium, the image forming apparatus 1 performs write and print processing on the tagged print medium. The write and print processing includes write processing in which tag information is written to each of a plurality of wireless tags of the tagged print medium, and print processing in which an image is printed on the tagged print medium. Specifically, in this case, the image forming apparatus 1 starts to convey the tagged print medium. After starting to convey the tagged print medium, the image forming apparatus 1 waits until the tagged print medium reaches a predetermined write position RA among positions on a conveyance path through which the tagged print medium passes by being conveyed. In the example shown in FIG. 1, the write position RA is a position located before two resist rollers 24 among possible positions of the tagged print medium conveyed by the image forming apparatus 1. After the tagged print medium reaches the write position RA, the image forming apparatus 1 suspends the conveyance of the tagged print medium and writes tag information to each of the plurality of wireless tags. After the write of tag information to each of the plurality of wireless tags is completed, the image forming apparatus 1 resumes the conveyance of the tagged print medium with the plurality of wireless tags, and prints an image on the tagged print medium. After printing the image on the tagged print medium, the image forming apparatus 1 heats the tagged print medium on which the image has been printed, and fixes the image onto the tagged print medium. After fixing the image onto the tagged print medium, the image forming apparatus 1 discharges the tagged print medium onto which the image has been fixed. The image forming apparatus 1 performs the above processing as the write and print processing for the tagged print medium. The forming processing described above refers to processing relating to printing of an image on the tagged print medium among the processing included in the write and print processing. The write processing described above refers to processing relating to writing of tag information to each of a plurality of wireless tags of the tagged print medium among the processing included in the write and print processing.

An image forming apparatus different from the image forming apparatus 1, such as a conventional image forming apparatus, detects individual wireless tags, for example, after conveying a tagged print medium to a position at which tag information is to be written to each of the plurality of wireless tags. The image forming apparatus then writes tag information to the wireless tag for each of the detected wireless tags. However, the time required to detect the plurality of wireless tags increases as the number of wireless tags attached to the print medium increases. This leads to a decrease in user convenience, which is not desirable.

In this regard, the image forming apparatus 1 selects each of the plurality of wireless tags of the tagged print medium one by one and writes tag information to the wireless tag for each of the selected wireless tags. This eliminates the need for the image forming apparatus 1 to detect the individual wireless tags and makes it possible to eliminate the time required to detect the wireless tags. As a result, the time required to write tag information to the wireless tags can be shortened. The method by which the image forming apparatus 1 selects each of the plurality of wireless tags one by one will be described below.

The image forming apparatus 1 includes, for example, a printer unit 11, a control panel 12, a wireless tag communication device 13, a manual feed tray TA, and a paper discharge tray TB. The image forming apparatus 1 may have a configuration including other members, other apparatuses, and the like in addition to the printer unit 11, the control panel 12, the wireless tag communication device 13, the manual feed tray TA, and the paper discharge tray TB. The image forming apparatus 1 may be configured without the wireless tag communication device 13. In this case, the image forming apparatus 1 is externally connected to the wireless tag communication device 13 to be communicable.

The printer unit 11 conveys a print medium and prints an image on the print medium, for example.

The control panel 12 includes an operation reception unit and a display unit.

The operation reception unit receives an operation from the user. The operation reception unit is an input device, for example, a touch pad or input keys. The operation reception unit outputs information indicating the operation received from the user to a control device 110 to be described below.

The display unit displays an image corresponding to the operation received via the operation reception unit. The display unit is an image display device, for example, a liquid crystal display or an organic electro luminescence (EL) display. Note that the display unit may be integrally configured with the operation reception unit as a touch panel.

The wireless tag communication device 13 radiates radio waves to the tagged print medium located at the aforementioned write position RA. The wireless tag communication device 13 has a flat plate-shaped enclosure as a whole and includes, inside the enclosure, an antenna 131 that radiates radio waves to the write position RA. The wireless tag communication device 13 radiates radio waves in a radiation direction from one surface to the other surface of two surfaces of the enclosure, among directions orthogonal to the two surfaces. The direction indicated by the arrow k shown in FIG. 1 is an example of the radiation direction. In FIG. 1, the write position RA is shown as a region surrounded by dotted lines. In other words, the tagged print medium located at the write position RA is located within the region surrounded by the dotted lines shown in FIG. 1.

The antenna 131 is, for example, a single antenna that radiates radio waves to the tagged print medium located at the write position RA. The antenna 131 may include a plurality of antennas instead of a single antenna.

The wireless tag communication device 13 causes the antenna 131 to radiate radio waves toward the tagged print medium located at the write position RA according to control from the control device 110 that controls the image forming apparatus 1. This allows the wireless tag communication device 13 to write tag information to each of the plurality of wireless tags of the tagged print medium.

### Configuration of Printer Unit

Hereinafter, a configuration of the printer unit 11 will be described.

The printer unit 11 includes the control device 110, a paper feed cassette 111, a paper feed cassette 112, and an image forming device 113.

The control device 110 controls the whole of the image forming apparatus 1. In other words, the control device 110 controls the printer unit 11, the control panel 12, the wireless tag communication device 13, and the image forming device 113.

The paper feed cassette 111 stores print media of the types desired by the user. As an example, the case where the paper feed cassette 111 stores tagged print media will be described.

The paper feed cassette 112 stores print media of the types desired by the user. As an example, the case where the paper feed cassette 112 stores tag-free print media will be described.

The image forming device 113 conveys a print medium and prints on the print medium an image indicated by image data acquired from the control device 110 according to the control from the control device 110. The image data is, for example, image data acquired from an information processing apparatus or the like that is communicably connected to the image forming apparatus 1.

The image forming device 113 includes an intermediate transfer belt 20. The image forming device 113 includes a driven roller 21, a backup roller 22, a secondary transfer roller 23, the two resist rollers 24, and a manual feeding roller 25. The image forming device 113 includes four sets of image forming stations of an image forming station 31, an image forming station 32, an image forming station 33, and an image forming station 34. The image forming device 113 includes a fixing device AD and a double-sided print device DF.

The intermediate transfer belt 20 is a belt on which a toner image is primary-transferred by the four sets of image forming stations. The intermediate transfer belt 20 is supported by the driven roller 21, the backup roller 22, and the like. The intermediate transfer belt 20 rotates in the direction indicated by the arrow m of FIG. 1. More specifically, the image forming device 113 rotates the intermediate transfer belt 20 in the above-mentioned direction by a motor not shown in the figure according to the control from the control device 110.

The image forming station 31 is an image forming station for forming Y (yellow) images. The image forming station 32 is an image forming station for forming M (magenta) images. The image forming station 33 is an image forming station for forming C (cyan) images. The image forming station 34 is an image forming station for forming K (black) images. In the image forming device 113, those four sets of image forming stations are disposed along the rotation direction of the intermediate transfer belt 20 on the lower side of the intermediate transfer belt 20.

The image forming station 31 includes a photoconductor drum 311, an electrostatic charger 312, an exposure scanning head 313, a developing device 314, a photoconductor cleaner 315, and a primary transfer roller 316. In the image forming station 31, the electrostatic charger 312, the exposure scanning head 313, the developing device 314, the photoconductor cleaner 315, and the primary transfer roller 316 are disposed around the photoconductor drum 311 that rotates in the direction indicated by the arrow n in FIG. 1. The primary transfer roller 316 faces the photoconductor drum 311 via the intermediate transfer belt 20.

The image forming station 32, the image forming station 33, and the image forming station 34 each have a configuration similar to that of the image forming station 31. Thus, hereinafter, description on the configurations of the image forming station 32, the image forming station 33, and the image forming station 34 will be omitted.

The secondary transfer roller 23 faces the backup roller 22 via the intermediate transfer belt 20. The secondary transfer roller 23 secondary-transfers the toner image, which has been primary-transferred onto the intermediate transfer belt 20, onto the print medium passing between the secondary transfer roller 23 and the intermediate transfer belt 20.

The two resist rollers 24 convey a print medium, which is taken out from each of the paper feed cassette 111, the paper feed cassette 112, and the manual feed tray TA by a conveyance mechanism not shown in the figure, between the secondary transfer roller 23 and the intermediate transfer belt 20.

The manual feeding roller 25 takes out a print medium from the manual feed tray TA and conveys it to the two resist rollers 24.

The fixing device AD is a device that fixes the toner image onto the print medium after the toner image has been secondary-transferred by the secondary transfer roller 23. More specifically, the fixing device AD heats the print medium while conveying the print medium by the rollers, and fixes the toner image, which has been secondary-transferred onto the print medium, onto the print medium.

The double-sided print device DF is a device that conveys the print medium, which is obtained after the toner image has been fixed onto the front surface by the fixing device AD, to the two resist rollers 24. The print medium with the front surface and the back surface being turned inside out is conveyed to the double-sided print device DF. Thus, in the print medium that has been conveyed between the two resist rollers 24 via the double-sided print device DF, an image is printed on the back surface of the print medium via the secondary transfer roller 23 and the fixing device AD.

### Operation of Image Forming Device

Hereinafter, an operation of the image forming device 113 will be described.

First, the operation of the four sets of image forming stations will be described using an example of the operation of the image forming station 31.

The image forming station 31 charges the photoconductor drum 311 by the electrostatic charger 312 and then exposes the photoconductor drum 311 by the exposure scanning head 313. Thus, the image forming station 31 forms an electrostatic latent image on the photoconductor drum 311. The image forming station 31 then causes the developing device 314 to develop the electrostatic latent image on the photoconductor drum 311. The developing device 314 develops the electrostatic latent image on the photoconductor drum 311, as a toner image, using a two-component developer formed of toner and carrier. The primary transfer roller 316 primary-transfers the toner image thus formed on the photoconductor drum 311 to the intermediate transfer belt 20. After this primary transfer is performed, the photoconductor cleaner 315 removes the toner remaining on the photoconductor drum 311.

The image forming station 31, the image forming station 32, the image forming station 33, and the image forming station 34 form a color toner image on the intermediate transfer belt 20 by the primary transfer rollers 316. The color toner image is formed by sequentially superimposing the toner images of Y (yellow), M (magenta), C (cyan), and K (black).

Next, an operation of the secondary transfer roller 23 will be described. The secondary transfer roller 23 collectively secondary-transfers the color toner image on the intermediate transfer belt 20 onto the print medium passing between the secondary transfer roller 23 and the intermediate transfer belt 20. In the following description, the “toner image” may refer to any one of a color toner image and a unicolor toner image. The toner image may be a toner image with decolorized toner.

Next, in the operation of the image forming device 113, an operation of conveying a print medium will be described.

In the nip of the two resist rollers 24, the print medium taken out from each of the paper feed cassette 111, the paper feed cassette 112, and the manual feed tray TA is flexed by a conveyance mechanism not shown in the figure. The leading edge of the print medium is thereby aligned. The two resist rollers 24 then convey the print medium between the secondary transfer roller 23 and the intermediate transfer belt 20 according to the timing for writing the tag information to the wireless tag at the write position RA, the timing for the image forming device 113 to transfer the toner image onto the print medium, and the like. The conveyance paths through which the print medium taken out from each of the paper feed cassette 111, the paper feed cassette 112, and the manual feed tray TA is conveyed to the two resist rollers 24 meet at a confluence section PA shown in FIG. 1.

In the image forming device 113, the two resist rollers 24, the fixing device AD, and the plurality of rollers of the double-sided print device DF form three conveyance paths of a conveyance path LA, a conveyance path LB, and a conveyance path LC. The conveyance path LA is a conveyance path from the confluence section PA to a branch section PB shown in FIG. 1. The conveyance path LB is a conveyance path that passes through the double-sided print device DF from the branch section PB to the confluence section PA. The conveyance path LC is a conveyance path from the branch section PB to the paper discharge tray TB.

The two resist rollers 24 start to rotate depending on the position of the toner image on the rotating intermediate transfer belt 20 and move the print medium to the position of the secondary transfer roller 23. Thus, the toner image formed on the intermediate transfer belt 20 is secondary-transferred onto the print medium by the secondary transfer roller 23. After the toner image is secondary-transferred onto the print medium, the secondary transfer roller 23 conveys the print medium to the fixing device AD along the conveyance path LA.

The fixing device AD is an example of the fixing device included in the image forming apparatus 1. The fixing device AD fixes the toner image, which has been secondary-transferred onto the print medium conveyed from the secondary transfer roller 23, onto the print medium while conveying the print medium. The fixing device AD includes, for example, a fixing member ADA, a pressurizing member ADB facing the fixing member ADA, and a heating unit. In FIG. 1, the heating unit is omitted to prevent the complicated illustration of the figure.

The fixing member ADA is a member having an endless circumferential surface. For example, the fixing member ADA is a belt-like member. The fixing member ADA comes into circumferential surface of the contact with the outer pressurizing member ADB. The fixing member ADA rotates together with the contacting pressurizing member ADB. Inside the fixing member ADA, a support member that rotatably supports the fixing member ADA is provided. In FIG. 1, the support member is omitted to simplify the figure.

The pressurizing member ADB is a roller that comes into contact with the outer circumferential surface of the fixing member ADA. A driving force of a motor is transmitted to the pressurizing member ADB via a gear or the like. In other words, the pressurizing member ADB rotates by the drive of the motor. The driving force of the motor may be configured to be transmitted to the fixing member ADA instead of being transmitted to the pressurizing member ADB.

The pressurizing member ADB is pressed against the outer circumferential surface of the fixing member ADA. The pressurizing member ADB forms a nip together with the fixing member ADA by being pressed against the fixing member ADA. In other words, the pressurizing member ADB forms a nip together with the fixing member ADA by coming into contact with the fixing member ADA.

The heating unit is a heating device that heats the fixing member ADA.

With the above configuration, the fixing device AD includes the heating unit that heats the print medium, and thus heats the print medium that passes between the fixing member ADA and the pressurizing member ADB, and fixes the toner image onto the print medium. Thus, the toner image that has been secondary-transferred by the secondary transfer roller 23 is printed as an image on the print medium. After the image is printed on the print medium, the fixing device AD conveys the print medium to the conveyance path LC. The print medium conveyed to the conveyance path LC is then discharged by rollers not shown in the figure.

In the case of the double-sided printing, after the image is printed on the front surface of the print medium and the entire print medium passes through the branch section PB, the rollers not shown in the figure convey the print medium to the conveyance path LB by switching back. Thus, the front surface and the back surface of the print medium are turned over. Subsequently, the plurality of rollers in the double-sided print device DF conveys the print medium to the nip of the two resist rollers 24 along the conveyance path LB. The print medium whose front surface and back surface are turned over is then conveyed along the conveyance path LA via the two resist rollers 24, and the toner image is fixed by the fixing device AD. Thus, the image is printed on the back surface of the print medium. The fixing device AD conveys the print medium in which the image is printed on the back surface to the conveyance path LC to discharge the print medium.

In such a manner, the secondary transfer roller 23, the two resist rollers 24, the fixing device AD, and the various rollers in the double-sided print device DF constitute a conveyance device H that conveys the print medium in the image forming apparatus 1.

### Functional Configuration of Control Device

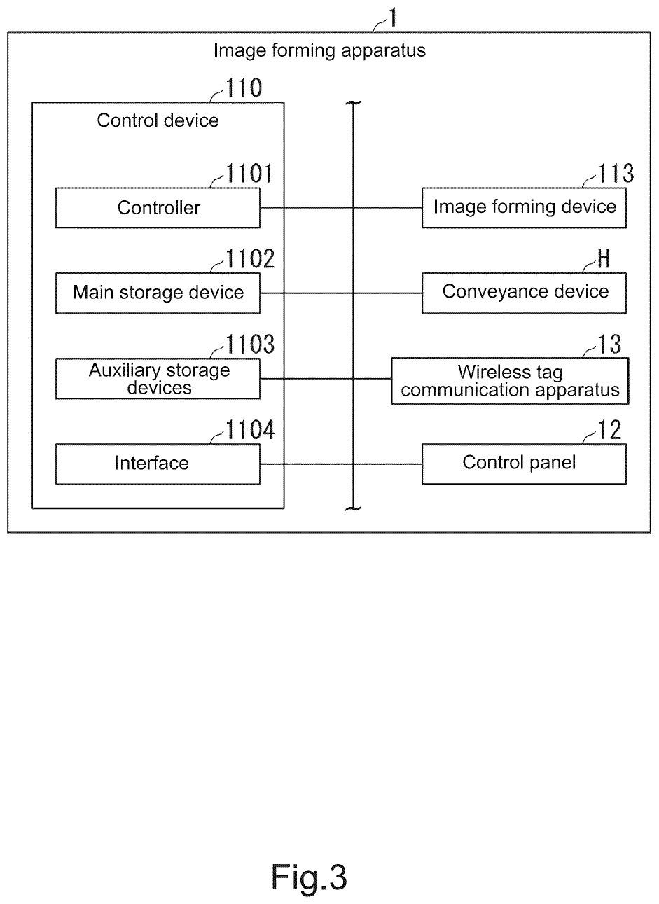

Next, a functional configuration of the control device 110 will be described with reference to FIG. 3. FIG. 3 is a diagram showing an example of a functional configuration of the control device 110.

As shown in FIG. 3, the control device 110 is communicably connected to each of the image forming device 113 of the printer unit 11, the conveyance device H, the control panel 12, and the wireless tag communication device 13 via a bus. The control device 110 includes, for example, a controller 1101, a main storage device 1102, an auxiliary storage device 1103, and an interface 1104.

The controller 1101 includes, for example, a

processor such as a central processing unit (CPU) or an application specific integrated circuit (ASIC). The controller 1101 controls the image forming device 113 of the printer unit 11, the conveyance device H, the control panel 12, and the wireless tag communication device 13 according to an image processing program stored in the auxiliary storage device 1103, and the like. The controller 1101 receives image data (e.g., data described in page description language, etc.) indicating images to be printed from a host such as a personal computer (PC), and stores the received image data in the auxiliary storage device 1103. Further, for example, the controller 1101 determines printing conditions from the image data stored in the auxiliary storage device 1103, and thus expands the image data into data that can be printed by the printer unit 11 (e.g., raster data) and stores the data in the main storage device 1102.

The main storage device 1102 is a read only memory (ROM), a random access memory (RAM), or the like.

The auxiliary storage device 1103 is a solid state drive (SSD), a hard disk drive (HDD), or the like. The auxiliary storage device 1103 may be provided separately from the control device 110. The auxiliary storage device 1103 is an example of a storage device.

The interface 1104 includes a connector to which a device connected to the control device 110 is connected, such as the wireless tag communication device 13.

The control device 110 thus configured may be integrated with the wireless tag communication device 13.

### Processing in Which Image Forming Apparatus Performs Write and Print Processing

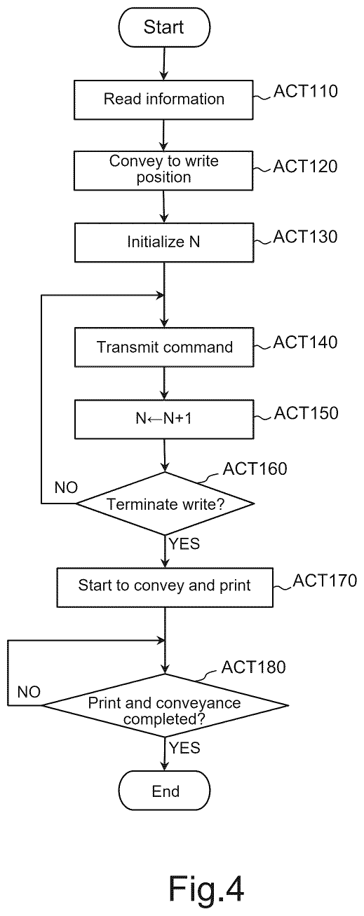

Hereinafter, processing in which the image forming apparatus 1 performs write and print processing will be described with reference to FIG. 4. FIG. 4 is a diagram showing an example of a processing flow in which the image forming apparatus 1 performs write and print processing. As an example, description will be given on the case where the image forming apparatus 1 receives, as a print job, a request to cause the image forming apparatus 1 to perform write and print processing and the image forming apparatus 1 causes the auxiliary storage device 1103 to store the received print job, at the timing before processing of ACT 110 shown in FIG. 4 is performed. As an example, description will be given on the case where the image forming apparatus 1 receives information indicating the type of print medium desired by a user at that timing. As an example, description will be given on the case where the type of print medium desired by the user is a tagged print medium stored in the feed cassette 111. As an example, description will be given on the case where the print job includes image-related information associated with each position of a plurality of wireless tags of the print medium desired by the user. As an example, description will be given on the case where the image-related information associated with a position of a certain wireless tag includes a combination of image data associated with the position of the wireless tag and tag information to be written to the wireless tag. As an example, description will be given on the case where the auxiliary storage device 1103 of the image forming apparatus 1 stores correspondence information indicating a correspondence relationship between a position of the wireless tag and a mask pattern associated with the wireless tag, for each of the plurality of wireless tags of the print medium desired by the user. A certain mask pattern includes wireless tag identification information for identifying a wireless tag associated with the mask pattern in the plurality of wireless tags of the print medium desired by the user. The wireless tag identification information is, for example, information indicating the position on the print medium, but it is not limited thereto. The information indicating the position on the print medium is, for example, an integer indicating the order of each of the plurality of wireless tags of the print medium, but it is not limited thereto. Note that the print job may include tag information to be written to each of the plurality of wireless tags of the print medium desired by the user, together with one piece of image data that is unrelated to each position of the plurality of wireless tags of the print medium desired by the user.

After the print job is received, the controller 1101 reads various types of information (ACT 110). Specifically, the controller 1101 performs the following processing in ACT 110. The controller 1101 reads all image-related information included in the received print job from the print job. The controller 1101 reads, from the auxiliary storage device 1103, the correspondence information indicating the correspondence relationship between the position of each of the plurality of wireless tags of the print medium desired by the user and the mask pattern. The controller 1101 performs the processing as described above in ACT 110. In FIG. 4, the processing of ACT 110 is represented as “Read information”.

Next, the controller 1101 controls the conveyance device H to convey a tagged print medium, which is placed on the paper feed cassette 111, to the write position RA (ACT 120). In FIG. 4, the processing of ACT 120 is represented as “Convey to write position”. The controller 1101 continues to convey the tagged print medium until the tagged print medium reaches the write position RA in ACT 120. In ACT 120, when the tagged print medium reaches the write position RA, the controller 1101 suspends the conveyance of the tagged print medium. Accordingly, the controller 1101 can locate the tagged print medium at the write position RA by the processing of ACT 120. The controller 1101 may be configured not to suspend the conveyance of the tagged print medium. In this case, the image forming apparatus 1 writes tag information to each of the plurality of wireless tags of the tagged print medium while conveying the tagged print medium.

Next, the controller 1101 generates a variable N for counting the number of times of repetitive processing in the storage area of the auxiliary storage device 1103, and initializes the value of the generated variable N to zero (ACT 130). N is a variable that stores an integer. In FIG. 4, the processing of ACT 130 is represented as “Initialize N”.

Next, the controller 1101 transmits various commands to the wireless tag communication device 13 (ACT 140). Specifically,, the controller 1101 performs the following processing in ACT 140. The controller 1101 selects one piece of unselected correspondence information in the correspondence information read from the auxiliary storage device 1103 in ACT 110, as target correspondence information, and identifies a mask pattern in a correspondence relationship indicated by the selected target correspondence information. The controller 1101 extracts image-related information associated with the identified mask pattern from all the image-related information read from the print job in ACT 110. On the basis of the extracted image-related information, the controller 1101 identifies tag information to be written to a wireless tag located at the position associated with the identified mask pattern. The controller 1101 transmits the identified mask pattern, the identified tag information, a selection command to select that wireless tag, and a write command to cause the wireless tag communication device 13 to write the tag information to the wireless tag, to the wireless tag communication device 13 via the interface 1104. For convenience of description, a combination of the mask pattern, the tag information, the selection command, and the write command will be referred to as transmission information. The controller 1101 performs the above processing in ACT 140. In FIG. 4, the processing of ACT 140 is represented as “Transmit command”. When the information indicating the position of the wireless tag is any integer from 1 to N, the controller 1101 may be configured to select correspondence information indicating a correspondence relationship between the position indicated by the value of N and the mask pattern associated with that position, as the target correspondence information, in ACT 140. When transmitting the transmission information to the wireless tag communication device 13, the controller 1101 may be configured to transmit some or all of the mask pattern, the tag information, the selection command, and the write command to the wireless tag communication device 13 in a predetermined order, or to transmit all of the mask pattern, the tag information, the selection command, and the write command to the wireless tag communication device 13 in a batch. In the transmission information, some or all of the mask pattern, the tag information, the selection command, and the write command may be combined as a single command. The method of combining some or all of the mask pattern, the tag information, the selection command, and the write command as a single command may be a known method or a method to be developed. The transmission information may be configured not to include a mask pattern. In this case, the controller 1101 separately transmits the transmission information and the mask pattern.

Next, the controller 1101 increments the value of the variable N stored in the auxiliary storage device 1103 by 1 (ACT 150). In FIG. 4, the processing of ACT 150 is represented as “N←N+1”.

Next, the controller 1101 determines whether to terminate write of the tag information to the plurality of wireless tags of the print medium located at the write position RA (ACT 160). For example, if the value of the variable N stored in the auxiliary storage device 1103 exceeds the number of pieces of image-related information included in the received print job, the controller 1101 determines to terminate the write. On the other hand, for example, if the value of the variable N stored in the auxiliary storage device 1103 is less than or equal to the number of pieces of image-related information included in the received print job, the controller 1101 determines not to terminate the write. In FIG. 4, the processing of ACT 160 is represented as “Terminate write?” The controller 1101 may be configured to determine whether to terminate the write by other methods in ACT 160.

If the controller 1101 determines not to terminate the write of the tag information to the plurality of wireless tags of the print medium located at the write position RA (ACT 160—NO), the controller 1101 proceeds to ACT 140 and selects unselected correspondence information to transmit various commands to the wireless tag communication device 13 again. If there is no unselected correspondence information in ACT 140, the controller 1101 proceeds to ACT 170.

Meanwhile, if the controller 1101 determines to terminate the write of the tag information to the plurality of wireless tags of the print medium located at the write position RA (ACT 160—YES), the controller 1101 proceeds to ACT 170.

On the basis of all the image-related information and correspondence information read in ACT 110, the controller 1101 controls the conveyance device H and the image forming device 113 to start to convey the print medium and print an image on the print medium (ACT 170). This allows the controller 1101 to print the image indicated by the image data associated with the position at each position of the plurality of wireless tags of the print medium located at the write position RA. In FIG. 4, the processing of ACT 170 is represented as “Start to convey and print”.

Next, the controller 1101 waits until the conveyance of the print medium and the print of the image on the print medium, which have been started in ACT 170, are completed (ACT 180). The controller 1101 may use any method to determine whether or not the conveyance of the print medium and the print of the image on the print medium, which have been started in ACT 170, are completed. In FIG. 4, the processing of ACT 180 is represented as “Print and conveyance completed?”

If the controller 1101 determines that the conveyance of the print medium and the print of the image on the print medium, which have been started in ACT 170, are completed (ACT 180—YES), the controller 1101 terminates the processing of the flowchart shown in FIG. 4.

As described above, the controller 1101 repeatedly transmits the tag information associated with the mask pattern, the selection command to select a wireless tag associated with the mask pattern among the plurality of wireless tags, and the write command to cause the wireless tag communication device 13 to write the tag information associated with the mask pattern, to the wireless tag communication device 13 via the interface 1104, for each mask pattern stored in the auxiliary storage device 1103. This eliminates the need for the controller 1101 to perform the processing of detecting the wireless tag. As a result, the time required to write the tag information to the wireless tags can be shortened.

### Processing in Which Wireless Tag Communication Device Writes Tag Information to Wireless Tag

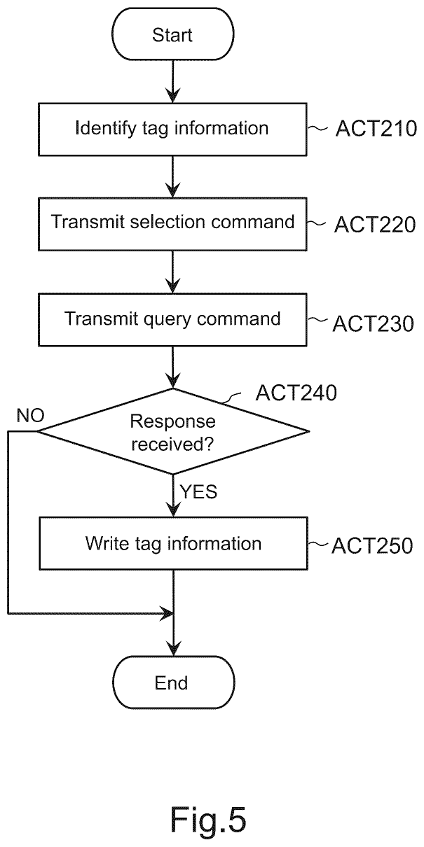

Hereinafter, processing in which the wireless tag communication device 13 writes tag information to a wireless tag will be described with reference to FIG. 5. FIG. 5 is a diagram showing an example of a processing flow in which the wireless tag communication device 13 writes tag information to a wireless tag. As an example, description will be given on the case where transmission information has been acquired from the control device 110 at the timing before processing of ACT 210 shown in FIG. 5 is performed.

After transmission information is acquired, the wireless tag communication device 13 identifies tag information included in the acquired transmission information (ACT 210).

Next, the wireless tag communication device 13

transmits a selection command to select a wireless tag associated with a mask pattern included in the acquired transmission information to the write position RA (ACT 220).

Next, the wireless tag communication device 13 transmits a query command to the write position RA (ACT 230). Accordingly, the wireless tag communication device 13 can cause the wireless tag to respond, the wireless tag being selected by the selection command transmitted in ACT 230 among the plurality of wireless tags of the print medium located at the write position RA.

Next, the wireless tag communication device 13 determines whether or not it has received a response to the query command transmitted in ACT 230 (ACT 240). Note that any method may be used to determine whether or not the wireless tag communication device 13 has received that response.

If the wireless tag communication device 13 determines that it has not received a response to the query command transmitted in ACT 230 (ACT 240—NO), for example, the wireless tag communication device 13 transmits to the control device 110 information indicating that the write of tag information has failed. The wireless tag communication device 13 then terminates the processing of the flowchart shown in FIG. 5.

On the other hand, if the wireless tag communication device 13 determines that it has received a response to the query command transmitted in ACT 230 (ACT 240—YES), the wireless tag communication device 13 writes the tag information included in the acquired transmission information to the wireless tag (ACT 250). The wireless tag communication device 13 then terminates the processing of the flowchart shown in FIG. 5.

As described above, the wireless tag communication device 13 can write the tag information to the wireless tag selected by the selection command on the basis of the acquired transmission information. This eliminates the need for the control device 110 to perform the processing of detecting the wireless tag. As a result, the time required to write the tag information to the wireless tag can be shortened.

The matters described above may be combined in any way.

A program for implementing the function of any constituent unit in the apparatus and devices described above (e.g., the image forming apparatus 1, the control device 110, and the wireless tag communication device 13) may be recorded on a computer-readable recording medium and read into a computer system to be executed. The “computer system” used herein includes an operating system (OS) or hardware such as a peripheral device. The “computer-readable recording medium” refers to a portable medium such as a flexible disk, a magneto-optical disk, a ROM, or a compact disk (CD)-ROM, or another storage device such as a hard disk built into a computer system. The “computer-readable recording medium” also includes one that retains a program for a certain period of time, like a volatile memory (RAM) inside a computer system that serves as a server or client when a program is transmitted via a network such as the Internet or a communication line such as a telephone line.

The program described above may be transmitted from a computer system that stores this program in the storage device or the like to another computer system via a transmission medium or by transmission waves in a transmission medium. The “transmission medium” for transmitting the program refers to a medium that has the function to transmit information, like a network (communication network) such as the Internet or a communication line (communication line) such as a telephone line. The program described above may be one for realizing some of the aforementioned functions. The program described above may be a so-called differential file (differential program) that can realize the aforementioned functions in combination with a program already recorded in the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device to control an image forming apparatus capable of forming an image on a print medium provided with a plurality of wireless tags, the control device comprising:
a storage device configured to store a mask pattern and tag information associated with the mask pattern for each of the plurality of wireless tags;
an interface connected to a wireless tag communication device capable of writing the tag information to the plurality of wireless tags; and
a controller configured to repeatedly transmit the tag information associated with the mask pattern, a selection command to select a wireless tag associated with the mask pattern among the plurality of wireless tags, and a write command to cause the wireless tag communication device to write the tag information associated with the mask pattern to the wireless tag communication device via the interface for each mask pattern stored in the storage device.

2. The control device according to claim 1, wherein
the mask pattern includes wireless tag identification information for identifying a wireless tag associated with the mask pattern among the plurality of wireless tags.

3. The control device according to claim 2, wherein
the wireless tag identification information indicates a position on the print medium.

4. The control device according to claim 1, wherein
the controller repeatedly transmits the tag information associated with the mask pattern, the selection command to select the wireless tag associated with the mask pattern among the plurality of wireless tags, and the write command to cause the wireless tag communication device to write the tag information associated with the mask pattern to the wireless tag communication device via the interface for each mask pattern stored in the storage device, for the print medium located at the write position, after the print medium is conveyed by the image forming apparatus to a write position at which the tag information is written to the plurality of wireless tags.

5. The control device according to claim 1, wherein
the controller causes the image forming apparatus to stop to convey the print medium after the print medium is conveyed by the image forming apparatus to a write position at which the tag information is written to the plurality of wireless tags.

6. The control device according to claim 1, wherein
the controller transmits the tag information, the selection command, and the write command to the wireless tag communication device in a predetermined order when a combination of the tag information, the selection command, and the write command is transmitted to the wireless tag communication device.

7. The control device according to claim 1, wherein
the controller transmits all of the tag information, the selection command, and the write command to the wireless tag communication device in a batch when a combination of the tag information, the selection command, and the write command is transmitted to the wireless tag communication device.

8. An image forming apparatus capable of forming an image on a print medium provided with a plurality of wireless tags, the image forming apparatus comprising:
an image forming device to form an image on the print medium; and
a control device to control image formation by the image forming device, wherein
the control device includes
a storage device configured to store a mask pattern and tag information associated with the mask pattern for each of the plurality of wireless tags,
an interface connected to a wireless tag communication device capable of writing the tag information to the plurality of wireless tags, and
a controller configured to repeatedly transmit the tag information associated with the mask pattern, a selection command to select a wireless tag associated with the mask pattern among the plurality of wireless tags, and a write command to cause the wireless tag communication device to write the tag information associated with the mask pattern to the wireless tag communication device via the interface for each mask pattern stored in the storage device.

9. The image forming apparatus according to claim 8, wherein
the storage device stores correspondence information indicating a correspondence relationship between a position of the wireless tag and the mask pattern associated with the wireless tag for each of the plurality of wireless tags.

10. The image forming apparatus according to claim 9, wherein
the controller causes the image forming device to print, when a print job including image data associated with each position of the plurality of wireless tags is received, an image at each position of the plurality of wireless tags on a basis of the correspondence information stored in the storage device and the print job, the image being indicated by the image data associated with each position.
